(19) United States
(12) Patent Application Publication
(10) Pub. No.: US 2018/0196688 A1
(43) Pub. Date: Jul. 12, 2018

(54) VIRTUAL MACHINE MANAGEMENT DEVICE, VIRTUAL MACHINE MANAGEMENT METHOD, AND NON-TRANSITORY COMPUTER READABLE MEDIUM

(71) Applicant: KABUSHIKI KAISHA TOSHIBA, Tokyo (JP)

(72) Inventor: Yu KANEKO, Kawasaki (JP)

(21) Appl. No.: 15/690,859

(22) Filed: Aug. 30, 2017

(30) Foreign Application Priority Data
Jan. 10, 2017 (JP) 2017-002067

(51) Int. Cl. G06F 9/455; G06F 9/50; G06F 9/48; G06F 1/08

(52) U.S. Cl. CPC G06F 9/45558; G06F 9/50; G06F 2009/4557; G06F 1/08; G06F 9/4881

(57) ABSTRACT

According to one embodiment, a virtual machine management device includes processing circuitry. The processing circuitry performs a simulation according to operation schedules of first to nth applications executable on first to nth virtual machines, the simulation performing, at a scheduling interval, to allocate virtual machines from the first to nth virtual machines to a plurality of physical CPUs in a physical machine, and cause the virtual machines allocated to the physical CPUs to execute the applications using the allocated physical CPUs. The processing circuitry determine whether performance requirements of the first to nth applications are satisfied based on times for which the first to nth applications are held on standby due to not allocating the physical CPU.

### CROSS REFERENCE TO RELATED APPLICATIONS

This application is based upon and claims the benefit of priority from the prior Japanese Patent Application No. 2017-002067, filed on Jan. 10, 2017, the entire contents of which are incorporated herein by reference.

### FIELD

Embodiments described herein relate to a virtual machine management device, a virtual machine management method, and a non-transitory computer readable medium.

### BACKGROUND

There is an application for performing monitoring control on equipment in buildings or factories. This application is called a monitoring control application. Examples of the monitoring control application include an application that periodically measures states (operating state, temperature, humidity, illuminance, etc.) of equipment (air-conditioning equipment and illumination equipment), and an application that adjusts the states of the equipment. The monitoring control application is demanded to precisely keep a time point to perform the processing (an operation time point) with a precision from about several milliseconds to several tens of milliseconds.

Besides, there is a virtualization technology of a computing machine. The virtualization is a technology to create a virtual computing machine (virtual machine: VM) on a physical machine (PM). The virtual computing machine refers to software that behaves as if to be a physical machine for an operating system (OS) or an application running on the OS.

Use of the virtualization enables an individual execution environment for each application to be prepared and enables a plurality of applications to be executed on a single PM. Therefore, the number of PMs required to build a certain system can often be reduced. When the number of PMs is reduced, it is possible to reduce a hardware cost of the system and to reduce amounts of power consumption and physical space consumed by the system.

In general, the virtualization decreases performance of an application. In particular, when a plurality of VMs are caused to run on a single PM, performance of an application drops. This is because computational resources such as a CPU and a memory mounted on a PM are shared among VMs. Meanwhile, from the viewpoint of a user of the monitoring control application, applications and VMs are intended to run on a PM as many as possible. This is because such a manner increases the cost reduction effect described above.

Therefore, it suffices to cause VMs to run on a single PM as many as possible while keeping performance of the monitoring control application executed on a VM.

A known related art is to predict degradation of performance of an application executed on a VM and add a VM until the performance is degraded. In this technique, a CPU utilization by a VM group is measured, and A) Total CPU utilization by the VM group is compared with B) A value of CPU resources of a PM. Then, when A reaches B, it is determined that the performance of the application is degraded. As the application, a Web server application is supposed.

However, in a case where the application is the monitoring control application, even when CPU utilization by a VM group is small, and there is some margin in CPU resources of a PM, an operation time point may be disturbed with an increase in the number of VMs. For example, there is a risk that an operation time point of the monitoring control application may be disturbed by several tens of milliseconds or more.

A cause of disturbance of the operation time point of the application despite some margin in the CPU resources is a CPU contention. The CPU contention is a phenomenon where, when a plurality of VMs intend to use some CPU at a certain time point, only one VM of them can use the CPU, and the other VMs cannot use the CPU. The other VMs are to wait for release of the CPU.

### BRIEF DESCRIPTION OF THE DRAWINGS

FIG. 1 illustrates a virtual machine (VM) management system that includes a virtual machine management device according to the present embodiment;

FIG. 2 is a conceptual diagram of virtualization;

FIG. 3 is a functional block diagram of the VM management device according to the present embodiment;

FIG. 4 is a diagram illustrating a relation between number of VMs and CPU contention time;

FIG. 5 is a diagram illustrating an overall schematic operation flow of the VM management device according to the present embodiment;

FIG. 6 is a diagram illustrating an integration example of an operation schedule according to the present embodiment;

FIG. 7 is a diagram schematically illustrating a virtual model of a physical machine and virtual models of virtual machines;

FIG. 8 is a diagram illustrating an operation flow of a simulation according to the present embodiment; and

FIG. 9 is a hardware block diagram of a computer according to the present embodiment.

### DETAILED DESCRIPTION

According to one embodiment, a virtual machine management device includes processing circuitry.

The processing circuitry performs a simulation according to operation schedules of first to nth applications executable on first to nth virtual machines, the simulation performing, at a scheduling interval, to allocate virtual machines from the first to nth virtual machines to a plurality of physical CPUs in a physical machine, and cause the virtual machines allocated to the physical CPUs to execute the applications using the allocated physical CPUs.

The processing circuitry determine whether performance requirements of the first to nth applications are satisfied based on times for which the first to nth applications are held on standby due to not allocating the physical CPU.

An embodiment of the present invention will be described below with reference to the drawings.

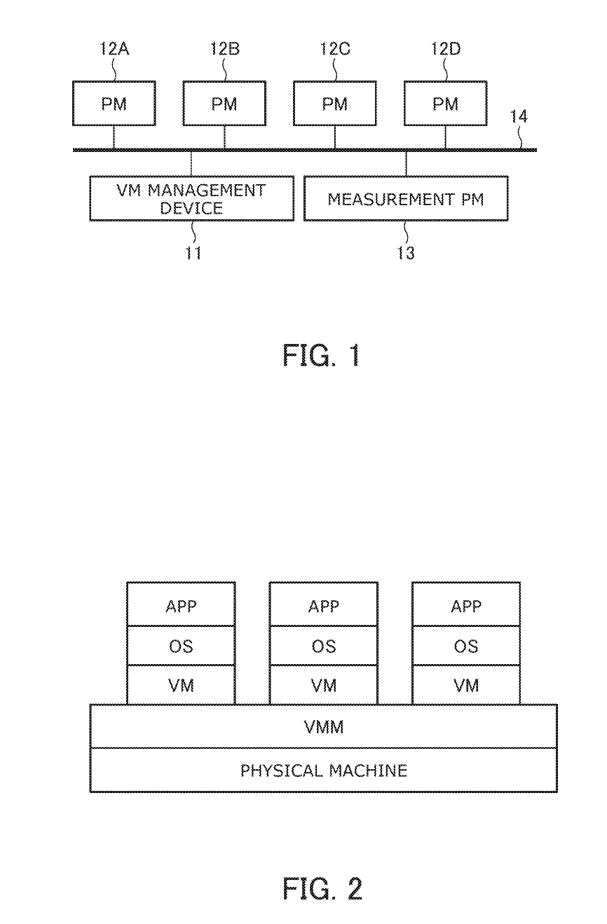

FIG. 1 illustrates a virtual machine (VM) management system that includes a virtual machine management device according to the present embodiment. The VM management system includes a VM management device 11, a plurality of physical machines (PMs) 12A, 12B, 12C, and 12D, and a measurement PM_13, which are connected to one another over a network 14. Hereinafter, PM_12 is supposed to refer to any one of the plurality of PMs_12A to 12D.

A PM_12 includes a plurality of central processing units (CPUs), a memory, and an input-output interface to the network 14. The memory may include a nonvolatile memory such as a DRAM or an SRAM, a nonvolatile memory such as a NAND, or both of them. PM_12 may include a storage device such as an SSD and a hard disk. Each of the plurality of CPUs included in a PM_12 may be denoted by a physical CPU (pCPU).

In the PM_12, one or more of virtual machines (VMs) are created by the virtualization technology for a computing machine. A VM refers to software that behaves as if to be a physical machine (PM) for an operating system (OS) or an application running on the OS. The OS and the application run on the VM.

FIG. 2 illustrates a conceptual diagram of virtualization. In a PM_12, virtualization software called a virtual machine monitor (VMM) is installed. Specific examples of VMMs include Xen, KVM, and other VMMs. Via a VMM, a plurality of VMs are operable on a PM. On each of the VMs, an OS and an application run. The application may be simply referred to as an app.

In the present embodiment, as an app, an app that repeats an identical operation on a given cycle is assumed. Specifically, it is a monitoring control app. An example of the monitoring control app is an app that monitors a sensor. Although it is assumed that the number of monitoring control apps running on each VM is one, but this is not intended to limit the present embodiment.

As an example of operation performed by a VMM, the VMM performs CPU scheduling at certain time intervals (given scheduling intervals). The CPU scheduling refers to determining which VM uses which pCPU, allocating the determined pCPU to the VM, and causing the VM to use the pCPU. A VM to which no pCPU is allocated as a result of the CPU scheduling cannot run.

The measurement PM_13 includes, as with the PM_12, a plurality of CPUs, a memory, and an input-output interface to the network 14. The measurement PM_13 is controlled by the VM management device 11. By installing a VMM, a VM, an OS and an app on the measurement PM_13, the VM and the app are made operable. As will be described later, the measurement PM_13 is used to grasp properties of an app that is intended to be newly added (installed). Each of the plurality of CPUs included in the measurement PM_13 may be referred to as a physical CPU (pCPU).

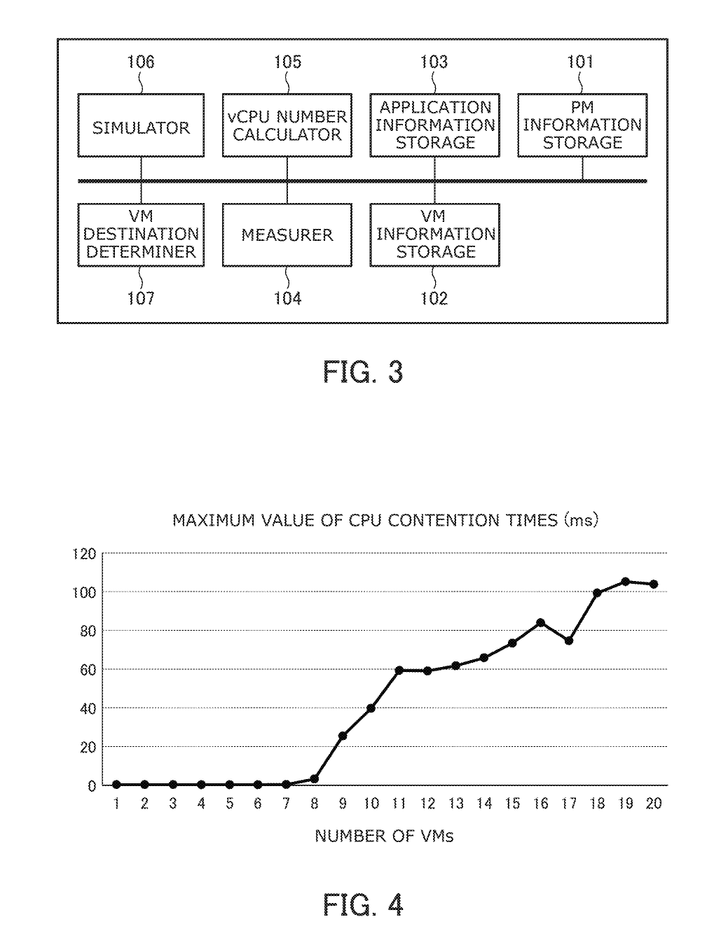

FIG. 3 illustrates a functional block diagram of the VM management device. The VM management device includes a PM information storage 101, a VM information storage 102, an application information storage 103, a measurer 104, a vCPU number calculator 105, a simulator (or CPU contention time estimating unit) 106, and a VM destination determiner (or determiner) 107. The measurer 104, the vCPU number calculator 105, the simulator 106, the VM destination determiner 107 or any combination thereof may be implemented by processing circuitry. In addition to these blocks, the VM management device may include an input unit with which a user inputs instructions or data, display for displaying data, and a communicator for exchanging data with an external device. In a case of adding a new app (monitoring control app), the VM management device determines a physical machine to which the app is added, from among the PM_12A to PM_12D. If there is no PM for the addition, the VM management device also determines to add a new PM to the network 14. To add an app, it is necessary to add a virtual machine that executes the app and an OS that interposes between the app and the virtual machine.

The PM information storage 101 is configured to store information on each PM connected to the network 14. As an example, information on a PM contains the followings.
ID to identify the PM
Host name of the PM
IP address
Number of the pCPUs included in the PM
Size of the memory included in the PM
Name of the virtualization software (VMM) installed in the PM
CPU scheduling interval
ID of a VM being running on the PM

The VM information storage 102 is configured to store information on a VM. As an example, information on a VM contains the followings.
ID to identify the VM
Host name of the VM
IP address
Number of virtual CPUs (vCPUs) included in the VM (in the VM, one or more of vCPUs are deployed, which run apps.)
Size of a memory that the VM virtually includes
ID of an app being running on the VM

The application information storage 103 is configured to store information on an app. As an example, information on an app contains the followings.
ID of the app
Execution schedule of the app
Performance requirements of the app

The operation schedule of an app and the performance requirements of the app will be described.

The operation schedule of an app is defined in terms of a cycle of an operation and an operation event. The operation event is defined in terms of a starting time point of the operation in the cycle and a time taken to complete the operation (processing time). That is, the operation schedule defines that a plurality of operation events are executed with different given timings.

The performance requirements of an app are defined in terms of a tolerable error of an operation time point (tolerance). The error of an operation time point is a difference between an operation time point defined in an operation schedule and a time point of an actual operation.

The measurer 104 is configured to perform processing for grasping properties of an app that is intended to be newly added. The measurer 104 is configured to prepare an execution environment including a VM, an OS, a VMM, and the like, for the measurement PM_13, and actually execute an app to be added on the VM to measure how many resources of a pCPU the app consumes, how much time the processing takes, and the like. For example, the measurer 104 grasps the amount of resource consumption of the pCPU per operation event and a processing time per operation event.

The vCPU number calculator 105 is configured to calculate, for each PM_12, the number of vCPUs to be installed on a VM to execute the app to be added, based on the properties of the app grasped by the measurer 104 (results of the measurement).

The simulator 106 is configured to simulate, for each PM_12, operation of an app already installed on the PM_12 and the app to be added, in a case of adding the app (and the VM and the OS). Specifically, the simulation selects a VM from between a VM already installed and the VM of the app to be added, allocates the VM to each of the plurality of pCPUs mounted on the PM_12, and causes the selected VM to execute the apps, at given scheduling intervals. Based on results of this simulation, a CPU contention time is calculated per app and per operation event. In the simulation, use is made of the result of the measurement, an operation schedule of each app, the calculated number of vCPUs, the number of pCPUs of each PM_12, and a CPU scheduling interval by the virtualization software (VMM).

CPU contention and CPU contention time will be described. The CPU contention is a phenomenon where, when a plurality of VMs intend to use some pCPU at a certain time point, only one VM of them can use the pCPU, and the other VMs cannot use the pCPU. The other VMs are to wait for release of the pCPU. A time to wait for this CPU release is called a CPU contention time.

FIG. 4 illustrates a relation between number of VMs and maximum value of CPU contention time. This diagram illustrates results of evaluation that is made using a PM including eight pCPUs (cores). The PM includes eight cores, and thus, from a time when the number of VMs is nine, a VM that can use no pCPUs, that is, the CPU contention occurs, and a CPU contention time increases. During the CPU contention time, the VMs cannot run apps, and thus operation time points of monitoring control apps are disturbed. When the number of VMs is 20, there is some margin in CPU resources of the PM, but an operation time point of an app is disturbed by several milliseconds to several tens of milliseconds. This disturbance raises a problem in a monitoring control app required that a time point (operation time point) of performing processing is kept precisely with a precision of several milliseconds to several tens of milliseconds.

The VM destination determiner 107 is configured to evaluate whether performance requirements of an app already installed on a PM_12 and performance requirements of an app to be added to the PM are satisfied, based on a time for which each app can use no pCPUs but is held on standby (in more detail, a CPU contention time calculated per operation event of each app) in the above simulation. This evaluation is made for each PM_12. Then, a PM_12 that satisfies the performance requirements of the app already installed and the performance requirements the app to be added is determined as a PM to which the app (and the VM and the OS) are to be added.

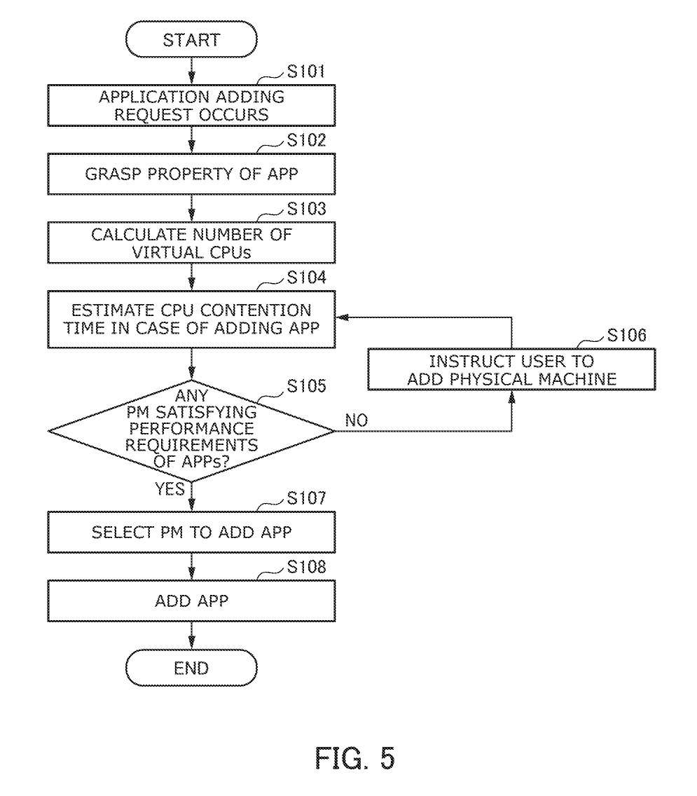

FIG. 5 schematically illustrates an operation flow of the VM management device.

An adding request of an app occurs (S101). For example, there is a case where equipment to be an object of monitoring control is added, and execution of an app supporting the equipment is intended. The adding request may be input by a user using an input unit, or the VM management device may receive the adding request from an external device over a communication network.

The measurer 104 of the VM management device receiving the adding request performs processing for grasping the properties of the app to be added (S102). The properties include amounts of CPU resources consumed by the app, and the like. Step S102 will be described later in detail.

After the properties of the app to be added are grasped, the vCPU number calculator 105 calculates the number of vCPUs to be mounted on a VM to execute the app to be added (S103). This step is executed for each candidate PM for the addition. That is, this step is performed for each of the PM_12A, PM_12B, PM_12C, and PM_12D. Step S103 will be described later in detail.

The simulator 106 estimates a CPU contention time in a case of adding the app, for each of the PM_12A to PM_12D (S104). Step S104 will be described later in detail.

The VM destination determiner 107 determines whether there is a PM that satisfies performance requirements of the app to be added and performance requirements of an app already installed, based on results of the estimation by the simulator 106 (S105).

If there is no PM that satisfies the performance requirements of the app to be added and the performance requirements of app already installed (NO in S105), information on instructions to add a PM is output to a user (S106). For example, instruction information on the addition of a PM may be displayed on a screen of a display device, or the instruction information may be transmitted to a user terminal. Upon receiving this instruction information, the user takes measures, for example, adding a new PM to the network 14, or the like. After the addition of the PM, the operation flow returns to step S104.

On the other hand, if there is one or more PMs that satisfy the performance requirements of the app to be added and the performance requirements of the app already installed (YES in S105), the VM destination determiner 107 selects a PM to which an app is added, from among the one or more PMs (S107). Step S107 will be described later in detail.

The VM destination determiner 107 adds the app (and the VM and the OS) to the selected PM (S108).

Steps S102, S103, S104, and S107 will be described below in detail.

### (S102: Grasping Properties of App)

The measurer 104 performs measurement of an app (benchmark) to grasp CPU resources consumed by the app and a time required for operation of the app. For this purpose, the measurer 104 boots up a VM on the measurement PM_13, and newly runs the app to be added on the VM. At this point, the measurer 104 causes the VM to mount (creates) one or more vCPUs thereon to grasp CPU resources needed by the app with high precision. An example, the measurer 104 performs the creation in such a manner that 80% of the number of pCPUs included in the measurement PM_13 are mounted on the VM. The VM, the app, an OS, and a VMM that run on the measurement PM_13 may be read from a storage device accessible from the VM management device and be installed on the measurement PM_13, or may be received from an external server or the like over the communication network. Some or all of the VM, the app, the OS, and the VMM may be installed on the measurement PM_13 in advance.

The measurer 104 causes the measurement PM_13 to execute the app for a period longer than an operation period of the app. During the execution of the app, measurement is made of a CPU time taken by a VM group (total time of use taken by a plurality of pCPUs mounted on the measurement PM_13), the number of CPU cycles required for processing in one event, a CPU utilization made by the VM group (total utilization made by the plurality of pCPUs mounted on the measurement PM_13).

For example, assume that, during the execution period of the app, the app processes N operation events, and the CPU time taken by the VM group measures U seconds. At this point, the measurer 104 calculates a number of CPU cycles Ce required for the processing of one event by the following expression.

$$\begin{matrix}[ Expression 1 ] & \\ {C}_{e} = \frac{( X \times U )}{N} & ( 1 )\end{matrix}$$

The variable “X” denotes the CPU clock rate (clock frequency) of the measurement PM_13, namely, a clock rate of the plurality of pCPUs included in the measurement PM_13. The plurality of pCPUs are assumed to have the same clock rate.

The measurer 104 measures the CPU utilization at an interval depending on a tolerance of the app. For example, when the tolerance of the app is 100 ms, the CPU utilization is measured at 100 ms intervals. The measurer 104 grasps a maximum CPU utilization in the execution period.

(S103: Calculating Number of vCPUs)

The vCPU number calculator 105 determines the number of vCPUs (N_{vcpu}) required for a VM to be added, in consideration of the CPU clock rate of the pCPUs of the measurement PM_13. N_{vcpu} is calculated by the following expression.

$$\begin{matrix}[ Expression 2 ] & \\ {N}_{vcpu} = ⌈ \frac{( maximum CPU utilization \times \frac{X}{Y} )}{100} ⌉ & ( 2 )\end{matrix}$$

The variable “X” is the clock rate of the pCPUs as in Expression (1). The variable “Y” is a clock rate of a PM_12 to which the VM may be added. The maximum CPU utilization is a value measured by the measurer 104.

┐z┐ [Expression 3]

is a ceiling function that returns a minimum integer equal to or larger than “z”.

For example, assume that the maximum CPU utilization is 150%, and “Y” is twice “X”. In this case, a value of an argument is 0.75, and thus “N_{vcpu}” is 1.

By using Expression (2), it is possible to estimate the number of vCPUs required for a VM with more precision.

### (S104: Estimation of CPU Contention Time)

The simulator 106 estimates a CPU contention time for each PM_12 (i.e., for each of the PMs_12A to 12D). Hereinafter, the number of pCPUs included in a PM_12 will be denoted by N_{cpu}.

The simulator 106 grasps the number of pCPUs of a PM_12 (N_{cpu}) and a VM group running on the PM_12.

The simulator 106 grasps the number of vCPUs included in each VM.

The simulator 106 grasps an operation schedule of each app in an app group running on each VM.

The simulator 106 acquires the number of vCPUs to be included in a VM to be added, from the vCPU number calculator 105, for each PM_12.

The simulator 106 acquires the number of cycles required to process one operation event of each app to be added, from the measurer 104.

The simulator 106 calculates a processing time Tₑ required to process one operation event of each app to be added, from the pCPU clock rate “Y”, by the following expression (3), for each PM_12.

$$\begin{matrix}[ Expression 4 ] & \\ {T}_{e} = \frac{{C}_{e}}{Y} & ( 3 )\end{matrix}$$

The simulator 106 acquires information on a processing time of an operation event by each app installed in (running on) each PM_12, from the application information storage 103.

The simulator 106 integrates an operation schedule of each app installed in (running on) each PM_12 and an operation schedule of an app to be newly added, so as to create an integrated schedule. At this point, the simulator 106 calculates the least common multiple of operation periods of the operation schedules and determines the least common multiple as the operation period of the integrated schedule. At this point, an operation start timing of an operation event of each operation schedule in the above operation period is kept. The simulator 106 also grasps information on which VM the operation event of each operation schedule occurs.

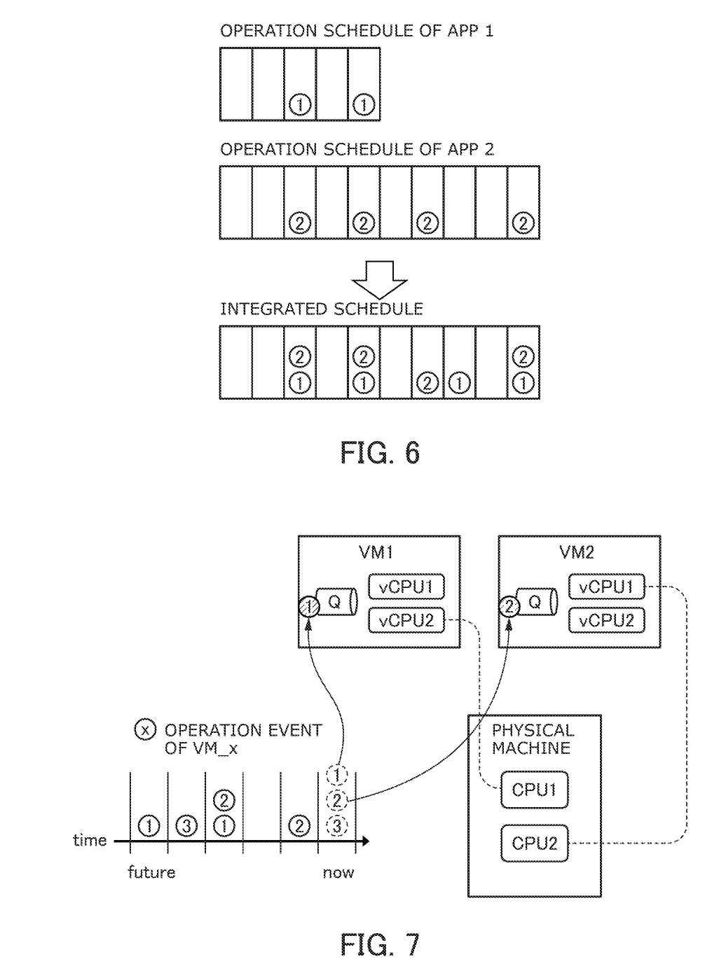

FIG. 6 illustrates an example of how the simulator 106 creates the integrated schedule. Circles represent operation events. A numeral in a circle is a number of an app that executes the operation event of the circle. Assuming that a unit time of an operation schedule is 1 second, an operation schedule of an app 1 is on a 5-second cycle, and an operation schedule of an app 2 is on a 10-second cycle in the diagram. Thus a cycle of the integrated schedule is 10 seconds.

The simulator 106 estimates the CPU contention time by creating a virtual model of a PM_12 and a virtual model of a VM group mounted on the PM_12, and by simulating operation of an app group.

FIG. 7 schematically illustrates a virtual model of the PM_12 and virtual models of VMs (although the diagram illustrates a virtual model of a VM1 and a virtual model of a VM2, virtual models of a VM3 and the subsequent VMs may be present). At the left of the diagram, operation events of the respective VM1, VM2, and VM3 are disposed on a time series basis, and an event closer to the right side is executed earlier.

The virtual model of the PM_12 includes one or more pCPUs (a CPU1 and a CPU2 in the diagram). Clock rates of the CPU1 and the CPU2 is Y.

The virtual model of the VM1 and the virtual model of the VM2 each include one or more vCPUs (a vCPU1 and a vCPU2 in the diagram) and one event queue. One vCPU can be linked to one pCPU at the same time. In addition, one pCPU can be linked to one vCPU at the same time. In addition, one vCPU can be linked to one operation event at the same time. One operation event may be linked to a plurality of vCPUs. In this case, one operation event can be executed on a plurality of vCPUs. An event queue is linked to an unlimited number of operation events.

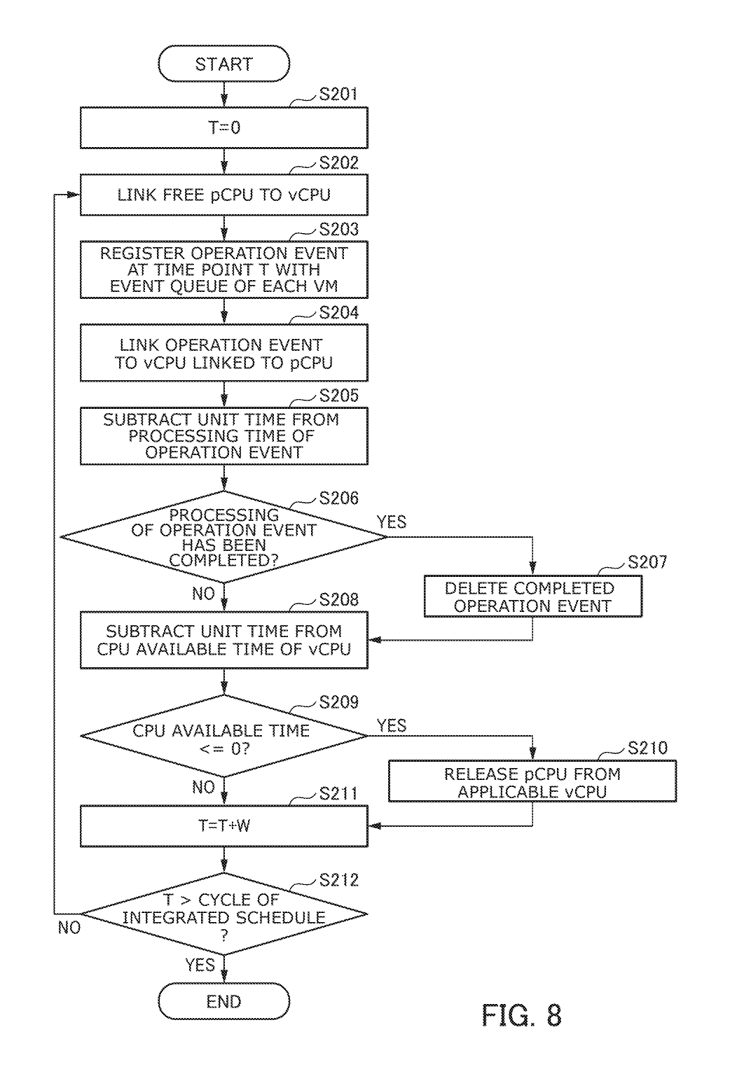

FIG. 8 illustrates a flowchart of the simulation performed by the simulator 106. In a case of adding an app to the PM_12 (each of the PM_12A to PM_12D), the simulator 106 simulates operation of an app already installed on the PM_12 and the app to be added.

The simulation is started at a simulation time point T=0 (S201). The simulation is performed in discrete time. Assume that a unit time of the simulation is denoted by W. A value of W is, as an example, a value equal to or less than an allowable delay of each of the apps.

If there is a free pCPU (linked to no vCPU), a vCPU that is caused to use the pCPU is determined (S202). A vCPU linked to an event is a candidate. This links each pCPU to any one of vCPUs of the plurality of VMs. There are some methods of how to select a vCPU.
A vCPU is selected at random from among all of the vCPUs linked to the event.
A vCPU is selected in such a manner that the number of times of being linked to a pCPU is equal among vCPUs.

To a vCPU newly linked to a pCPU, a pCPU available time of a fixed value is assigned. While the pCPU available time is greater than zero, the vCPU can use the pCPU. The value of the pCPU available time is made the same as a value of the CPU scheduling interval of the virtualization software, the value of the CPU scheduling interval being stored in the PM information storage 101.

An operation event E(t) at a time point T of the integrated schedule is checked. A plurality of operation events (E_1, E_2, . . . , E_i, . . . , E_x) may be present. Then, the events E_i are registered with the event queue of the VM in question (S203).

Next, the following processing is performed for a vCPU included in each VM.

If a vCPU is linked to a pCPU, the vCPU is linked to no operation event, and an event is present in an event queue, one operation event is selected and the selected operation event is linked to the vCPU (S204). The operation event may be selected by the First In First Out (FIFO) or may be selected at random.

A vCPU linked to an operation event can process the operation event when the vCPU is linked to a pCPU. Therefore, the unit time W of the simulation is subtracted from a processing time of the operation event (S205). When the processing time of the operation event becomes equal to or less than a predetermined value (here, equal to or less than zero), processing of the operation event is considered to be completed (S206), and the operation event is deleted (S207). The link between the operation event and the vCPU is also deleted. The processing time of the app to be added is equivalent to the aforementioned processing time Tₑ, and a processing time of the other app is stored in the application information storage 103. That is, the processing time of the other app is acquired in advance.

Now, there is a case where, as a result of completion of the processing of an operation event, another operation event occurs after a given amount of time. For example, there is an operation event to process a response that is asynchronously returned for a sent request. In this case, the other operation event is added to the integrated schedule.

If the vCPU is linked to the pCPU, the unit time W of the simulation is subtracted from a pCPU available time of the vCPU (S208). When the pCPU available time becomes equal to or less than a reference value (here, equal to or less than zero) (YES in S209), the link between the vCPU and the pCPU is discarded (S210). That is, the pCPU that is used by this vCPU thus far becomes free. In a case where the vCPU has not yet completed the execution of the operation event, the operation event remains stayed in the event queue, and when the vCPU is next linked to a pCPU, the rest of the operation event is executed. Therefore, the subtracted value of the processing time of the operation event calculated in step S205 is temporarily stored so as to be repeatedly used.

The simulation time point is advanced. That is, T=T+W (S211). Until T reaches one operation period of the integrated schedule, the simulation is continued (NO in S212). If T reaches one operation period of the integrated schedule (YES in S212), the simulation is terminated.

The simulator 106 estimates a CPU contention time for each operation event from results of conducting the simulation. The CPU contention time is a total of a time for which the operation event is held on standby in the event queue and a time for which the vCPU is held standby until completion of processing of the operation event. To be exact, the CPU contention time is a total of the following time T1 and time T2.

Time T1: a time from registration of an operation event with an event queue of a VM until the operation event is linked to a vCPU

Time T2: in a case where an operation event is linked to a vCPU, and the vCPU is delinked from a pCPU before completion of processing of the operation event, a time of the delinkage is time T2

The simulator 106 calculates at least one of indicators such as a maximum value and a 99th percentile value (99th value) of CPU contention times in all of the apps, based on the CPU contention time calculated for each operation event. As a modification, a maximum value and a 99th value of CPU contention times may be calculated for each app.

In a case of using the CPU affinity, an operation event having an affinity with a VM can be processed without contention. Therefore, the above processing may be performed with the VM and a pCPU to be occupied excluded.

The above-described estimation processing of a CPU contention time includes a random element such as processing to select a vCPU to be linked to a pCPU. Therefore, when the estimation processing is performed a plurality of times, an estimated CPU contention time can vary for each estimation processing. Thus, the estimation processing may be performed a plurality of times, results of the performances may be subjected to statistical processing, and the resultant thereof may be determined as a final CPU contention time. For example, the estimation processing is performed 30 times, and a maximum value, an average value, or other statistics of CPU contention times by the performances may be calculated.

(S107: Selecting PM to which App is to be Added)

The VM destination determiner 107 evaluates whether performance requirements of apps (apps already existing in the PM and an app to be newly added) are satisfied, using results of estimating a CPU contention time for each PM_12. Then, a PM satisfying performance requirements of all of the installed apps and the performance requirements of the app to be added is selected as an adding destination of the app (and a VM and an OS). Satisfying performance requirements of an app means, for example, the followings. In the following examples, both of the following two performance requirements may be requested, or only one of them may be requested. As a modification, use may be made of a maximum value and a 99th percentile value of CPU contention times calculated for each app.
Processing timing error tolerated by each app>Maximum value of CPU contention times
Processing timing error tolerated by each app>99th percentile value of CPU contention times

In a case where there are a plurality of PMs satisfying the performance requirements of the apps, one PM may be selected from among the plurality of PMs. How to select the PM is as follows.
PM having the smallest number of VMs
PM having the smallest total amount (total number of times or total processing time) of operation events
PM having the shortest CPU contention time after the addition

Upon selecting the PM to which the app is added, the VM destination determiner 107 updates an ID of a running VM stored in the PM information storage 101. To the ID of the running VM, an ID of the selected VM is added. In addition, information on the added app and information on the added VM are stored in the application information storage 103 and the VM information storage 102, respectively.

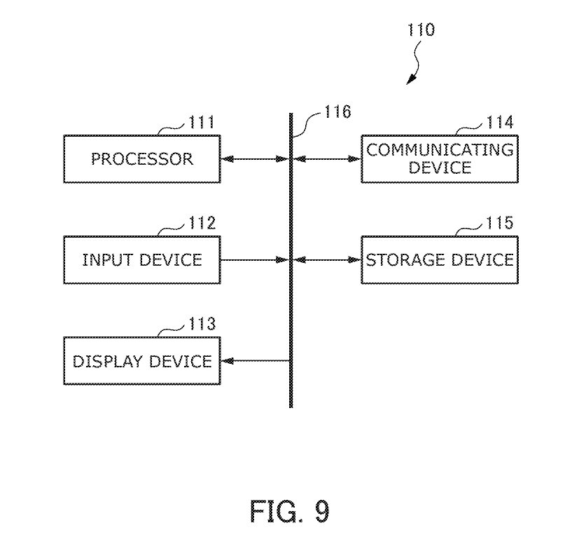

A hardware configuration of the VM management device according to the present embodiment will be described with reference to FIG. 9. The VM management device according to the present embodiment is constituted by a computer 110. The computer 110 includes a server, a client, a microcomputer, a general-purpose computer and the like. FIG. 9 is a diagram illustrating an example of the computer 110.

The computer 110 illustrated in FIG. 9 includes a central processing unit (CPU) 111, an input device 112, a display device 113, a communicating device 114, and a storage device 115. The processor 111, the input device 112, the display device 113, the communicating device 114, and the storage device 115 are connected to one another through a bus 116.

The processor 111 is an electronic circuit including a control device and an arithmetic device of the computer 110. As the processor 111, for example, use can be made of a general-purpose processor, a central processing unit (CPU), a microprocessor, a digital signal processor (DSP), a controller, a microcontroller, a state machine, an application-specific integrated circuit, a field programmable gate array (FPGA), a programmable logic device (PLD), and a combination thereof.

The processor 111 is configured to perform calculation processing based on data and a program input from devices (e.g., the input device 112, the communicating device 114, and the storage device 115) connected through the bus 116, and to output results of the calculation and a control signal to devices (e.g., the display device 113, the communicating device 114, and the storage device 115) connected through the bus 116. Specifically, the processor 111 is configured to execute an operating system (OS), a VM management program, and the like on the computer 110, and to control the devices constituting the computer 110.

The VM management program is a program to implement the above-described functional configurations of the VM management device, on the computer 110. The VM management program is stored in a non-transitory, tangible computer readable storage medium. The above storage medium is, for example, but not limited to, an optical disk, a magneto-optical disk, a magnetic disk, a magnetic tape, a flash memory, and a semiconductor memory. By the processor 111 executing a sensor design support program, the computer 110 functions as the VM management device.

The input device 112 is a device that allows information to be input into the computer 110. The input device 112 is, for example, but not limited to, a keyboard, a mouse, and a touch panel. A user can make various settings using the input device 112.

The display device 113 is a device for displaying an image or a video. The display device 113 is, for example, but not limited to, a liquid crystal display (LCD), a cathode-ray tube (CRT), and a plasma display panel (PDP). The display device 113 displays a GUI or a CUI. In addition, the display device 113 may display various kinds of data stored in the storages 101, 102, and 103, and results calculated by the measurer 104, the vCPU number calculator 105, the simulator 106, and the VM destination determiner 107.

The communicating device 114 is a device for allowing the computer 110 to communicate with an external device in a wireless or wired manner. The communicating device 114 is, for example, but not limited to, a modem, a hub, and a router. Data to be stored in the storages 101 to 103 or a VM and an app to be installed on a PM may be input from an external device via the communicating device 114 and stored in the storage device 115.

The storage device 115 is a hardware storage medium that stores an OS of the computer 110, the VM management program, data required for execution of the VM management program, data generated by the execution of the VM management program, and the like. The storage device 115 includes a main storage device and an external storage device. The main storage device is, for example, but not limited to, a RAM, a DRAM, and an SRAM. The external storage device is, for example, but not limited to, a hard disk, an optical disk, a flash memory, and a magnetic tape.

The computer 110 may include one or more processors 111, one or more input devices 112, one or more display devices 113, one or more communicating devices 114 and one or more storage devices 115, and may be connected to peripheral equipment such as a printer and a scanner.

The VM management device may be constituted by a single computer 110 or may be constituted as a system consisting of a plurality of computers 110 that are connected to one another.

Furthermore, the VM management program may be stored in the storage device 115 of the computer 110 in advance, may be stored in an external storage medium of the computer 110, or may be uploaded on the Internet. In any of the cases, by installing and executing the VM management program on the computer 110, the functions of the VM management device are implemented.

As described above, according to the present embodiment, in a case of adding an app and a VM to a PM, it is possible to determine whether there is a performance problem with the app such as whether a CPU contention time satisfies performance requirements of the app, before the addition, with high precision. This enables reduction of a risk that a problem occurs in terms of performance of the app after the addition of the app and the VM. In addition, since whether the performance requirements of the app are satisfied can be automatically determined, it is possible to reduce time and trouble of checking performance in detail through evaluation using an actual machine by a person.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

1. A virtual machine management device, comprising:
processing circuitry to perform a simulation according to operation schedules of first to nth applications executable on first to nth virtual machines, the simulation performing, at a scheduling interval, to allocate virtual machines from the first to nth virtual machines to a plurality of physical CPUs in a physical machine, and cause the virtual machines allocated to the physical CPUs to execute the applications using the allocated physical CPUs; and
determine whether performance requirements of the first to nth applications are satisfied based on times for which the first to nth applications are held on standby due to not allocating the physical CPU.

2. The virtual machine management device according to claim 1, wherein
the first to n−1th virtual machines and the first to n−1th applications are installed on the physical machine,
the nth virtual machine and the nth application are candidates to be newly added to the physical machine, and
the processing circuitry determines that the nth virtual machine and the nth application are addible to the physical machine in a case where performance requirements of the first to nth applications are satisfied.

3. The virtual machine management device according to claim 2, wherein
the operation schedules of the first to nth applications are defined based on first to nth operation periods and one or more first to nth operation events disposed in the first to nth operation periods,
the processing circuitry calculates CPU contention times for the first to nth operation events based on times for which execution of the first to nth operation events are held on standby due to not allocating the physical CPU, and
the processing circuitry determines whether performance requirements of the first to nth applications are satisfied, based on the CPU contention times.

4. The virtual machine management device according to claim 3, wherein the processing circuitry measures a number of CPU cycles required to process the nth operation event, using a measurement physical machine on which the nth virtual machine and the nth application are installed, wherein
the processing circuitry calculates, based on the number of CPU cycles, an nth processing time being a processing time required for execution of the nth operation event at a CPU clock rate of the physical machine, previously acquires first to n−1th processing times being processing times taken to execute the first to n−1th operation events, and executes the first to nth operation events by subtracting a unit time from the first to nth processing times respectively whenever allocating the physical CPU to the first to nth virtual machines.

5. The virtual machine management device according to claim 4, wherein the processing circuitry measures a processing time taken to process the nth operation event on the measurement physical machine, and measures the number of CPU cycles based on the measured processing time and a CPU clock rate of the measurement physical machine.

6. The virtual machine management device according to claim 3, wherein
the first to nth virtual machines each include at least one virtual CPU, and
the processing circuitry allocates virtual CPUs from among virtual CPUs in the first to nth virtual machines to the plurality of physical CPUs, and causes the allocated virtual CPUs to execute respective operation events using the allocated physical CPUs.

7. The virtual machine management device according to claim 6, wherein the processing circuitry selects, at random, virtual CPUs to be allocated to the plurality of physical CPUs, from among the virtual CPUs in the first to nth virtual machines.

8. The virtual machine management device according to claim 6, wherein the processing circuitry measures a CPU utilization of the measurement physical machine by the nth virtual machine,
the processing circuitry calculates a number of virtual CPUs to be mounted on the nth virtual machine used in the simulation, based on the CPU utilization, a CPU clock rate of the measurement physical machine, and a CPU clock rate of the physical machine, and
the processing circuitry uses the nth virtual machine on which virtual CPUs as many as the number of virtual CPUs are mounted.

9. The virtual machine management device according to claim 8, wherein
the processing circuitry measures the CPU utilization at a time interval depending on a performance requirement of the nth application, and
the processing circuitry calculates the number of virtual CPUs based on a maximum value of the CPU utilization.

10. The virtual machine management device according to claim 3, wherein the processing circuitry determines whether the performance requirements of the first to nth applications are satisfied, based on a maximum value or a 99th percentile value of each of the CPU contention times that are calculated for the first to nth operation events.

11. The virtual machine management device according to claim 2, wherein
the processing circuitry also performs the simulation on second to Mth physical machines, and
the processing circuitry selects a physical machine satisfying the performance requirements of the first to nth applications, from among the physical machine and the second to Mth physical machines, and determines that the nth virtual machine and the nth application are added to the selected physical machine.

12. A virtual machine management method, comprising:
performing a simulation according to operation schedules of first to nth applications executable on first to nth virtual machines, the simulation performing, at a scheduling interval, to allocate virtual machines from the first to nth virtual machines to a plurality of physical CPUs in a physical machine, and cause the virtual machines allocated to the physical CPUs to execute the applications using the allocated physical CPUs; and
determining whether performance requirements of the first to nth applications are satisfied based on times for which the first to nth applications are held on standby due to not allocating the physical CPU.

13. A non-transitory computer readable medium having a program stored therein which causes a computer when executed by the computer to perform processing comprising:
performing a simulation according to operation schedules of first to nth applications executable on first to nth virtual machines, the simulation performing, at a scheduling interval, to allocate virtual machines from the first to nth virtual machines to a plurality of physical CPUs in a physical machine, and cause the virtual machines allocated to the physical CPUs to execute the applications using the allocated physical CPUs; and
determining whether performance requirements of the first to nth applications are satisfied based on times for which the first to nth applications are held on standby due to not allocating the physical CPU.
